(19) United States
(12) Patent Application Publication
(10) Pub. No.: US 2016/0162793 A1
(43) Pub. Date: Jun. 9, 2016

(54) METHOD AND APPARATUS FOR DECISION TREE BASED SEARCH RESULT RANKING

(71) Applicant: Alibaba Group Holding Limited, George Town (KY)

(72) Inventors: Zhiwei WANG, Beijing (CN); Xiaotong PAN, Beijing (CN); Zhongyi LIU, Beijing (CN); Hu WEI, Hangzhou (CN)

(21) Appl. No.: 14/959,375

(22) Filed: Dec. 4, 2015

(30) Foreign Application Priority Data
Dec. 5, 2014 (CN) 201410742828.4

(51) Int. Cl. G06N 5/04; G06F 17/30; G06N 99/00

(52) U.S. Cl. CPC G06N 5/045; G06N 99/005; G06F 17/3053

(57) ABSTRACT

A method of decision tree based search result ranking includes obtaining a training data set for generating at least one decision tree, the training data set having N training features and N greater than or equal to 2. The method further includes dividing a computational system of decision trees into N feature work groups corresponding to the N training features respectively, and by use of the feature work groups, computing splitting nodes and splitting values corresponding to the splitting nodes for the decision trees. The method also includes generating the decision trees using the computed splitting nodes and the corresponding splitting values; and ranking search results using the decision trees.

### CROSS REFERENCE TO RELATED APPLICATION

This application claims the benefits to Chinese Patent Application No. 201410742828.4, filed on Dec. 5, 2014, which is incorporated herein by reference in its entirety.

### TECHNICAL FIELD

The present disclosure relates generally to data searching, and more particularly to decision tree based search result ranking.

### BACKGROUND

With rapid developments of the Internet technologies, search engines are becoming a primary approach for users to obtain information of interest. In general, a user enters into a search engine key words or key phrases to search for such information of interest. Different search engines generally utilizes different ranking factors to rank the search results returned and then present to the user the returned search results in a ranked order.

For the existent search engines, due to various user habits of entering key words or key phrases, as well as each search engine's different computation of degrees of relevance between search results and key words/phrases, the ranking results vary accordingly. In order to obtain search results satisfactory to users, nowadays a commonly practiced approach is to utilize machine learning methods to establish ranking models, and then apply the established ranking models to rank the search results. The decision tree model, a classic model of machine learning methods, handles both classification and regression analysis. The GBDT (Gradient Boosting Decision Tree), one of the decision tree models, essentially utilizes regression decision trees to solve ranking problems.

However, regardless of which types of decision trees are utilized to establish ranking models, a ranking model can only be established by training with training data sets with known relevance between the search key words/phrases and search results. In general, training data sets include hundreds of millions of data, to train a ranking model with such a large amount of data is significantly time-consuming. Further, for different search key words/phrases entered for different fields, a large number of different ranking models need to be established, let alone the problem of data updating. Therefore, there exists a need to improve the efficiency of establishing ranking models.

### SUMMARY

An object of the present invention is to provide a decision tree based search result ranking method and apparatus for, when training with data sets of large volumes of data, e.g., hundreds of millions of data, decreased the amount of computational time, improved ranking efficiency and ranking flexibility, and lowered ranking associated costs, to a great extent.

To solve the above described technical problems, according to an exemplary embodiment in accordance with the present disclosure, a method of decision tree based search result ranking includes obtaining a training data set for generating at least one decision tree which is used for ranking, the training data set having N training features and N being a natural number greater than or equal to 2. The method further includes dividing the computational system of the decision trees into N feature work groups, each feature work group corresponding to a training feature of the N training features. The method also includes, by use of the feature work groups, computing splitting nodes and splitting values corresponding to the splitting nodes for the decision trees. The method also includes generating the decision trees using the computed splitting nodes and the corresponding splitting values; and ranking search results using the decision trees.

According to another exemplary embodiment in accordance with the present disclosure, an apparatus for ranking search results based on decision trees includes a processor and a non-transitory computer-readable medium operably coupled to the processor. The non-transitory computer-readable medium has computer-readable instructions stored thereon to be executed when accessed by the processor. The instructions include an acquisition module, a division module, a computing module and a ranking module. The acquisition module is configured for obtaining a training data set for generating at least one decision tree, the training data set having N training features and N greater than or equal to 2. The division module is configured for dividing a computational system of decision trees into N feature work groups corresponding to the N training features respectively. The computing module is configured for, by use of the feature work groups, computing splitting nodes and splitting values corresponding to the splitting nodes for the decision trees; and for generating the decision trees using the computed splitting nodes and the corresponding splitting values. The ranking module is configured for ranking search results using the decision trees.

In comparison with existent technologies, embodiments in accordance with the present disclosure provide for the following differences and effects: the usage of dividing the computational system of decision trees into feature work groups based on training features, and the parallel computation and transmission of information based on the feature work groups, provides for training with training data sets of significantly large volumes, e.g., hundreds of millions of data, with decreased computational time. Especially for search engines with large correspondent databases, it provides for fast and precise training for a good quality decision tree to be used for ranking, increasing ranking efficiency and ranking flexibility, as well as lowering ranking associated costs.

Furthermore, the usage of dividing the computational system of decision trees in the two dimensions of training features and training samples at the same time further provides for increased training efficiency for training data sets. For example, for a training data set with 3 hundreds of millions data, a good quality decision tree model can be trained within few hours.

The details of one or more embodiments of the disclosure are set forth in the accompanying drawings and the description below. Other features, objects, and advantages of the disclosure will be apparent from the description and drawings, and from the claims.

### DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a flow chart of an exemplary method of decision tree based search result ranking in accordance with a first embodiment of the present disclosure;

FIG. 2 is a schematic diagram of exemplary feature work groups of a computational system of decision trees divided using MPI protocols, in accordance with a second embodiment of the present disclosure;

FIG. 3 is a schematic diagram of an exemplary distributed memory data structure of a feature work group of a computational system of decision trees divided using MPI protocols, in accordance with a second embodiment of the present disclosure; and

FIG. 4 is a block diagram of an exemplary apparatus for decision tree based search result ranking in accordance with a third embodiment of the present disclosure.

### DETAILED DESCRIPTION

In the following description, numerous specific details are set forth in order to provide a thorough understanding of the present disclosure. However, it will become obvious to those skilled in the art that the present disclosure may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the disclosure do not inherently indicate any particular order nor imply any limitations in the disclosure.

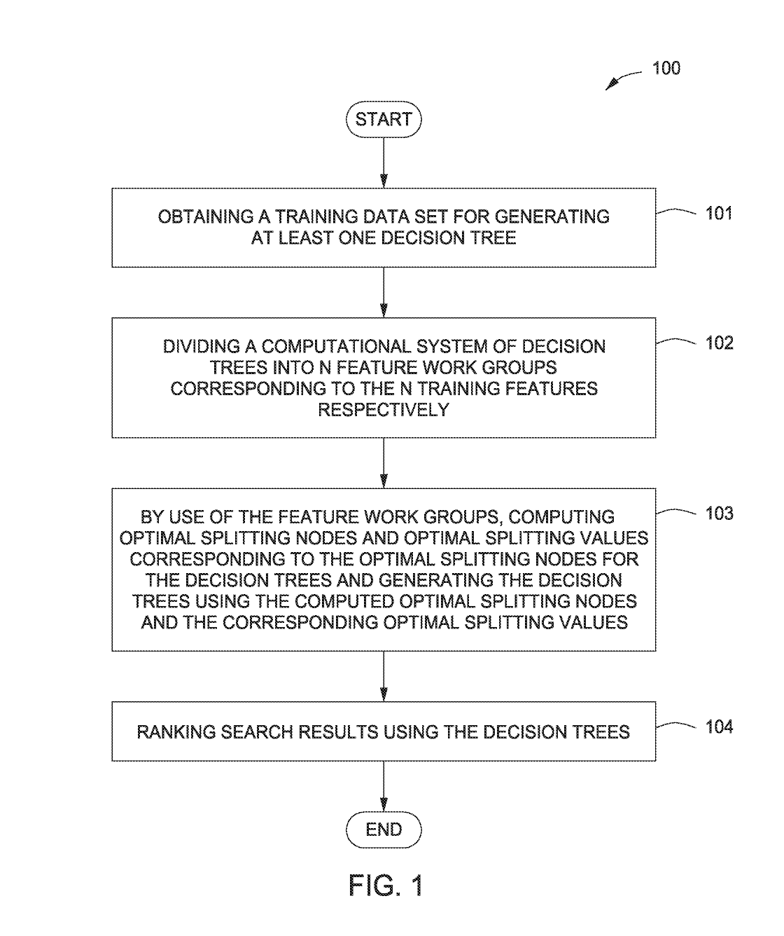

Embodiments of the present disclosure are discussed herein with reference to FIGS. 1-4. However, those skilled in the art will readily appreciate that the detailed description given herein with respect to these figures is for explanatory purposes as the disclosure extends beyond these limited embodiments.

Referring to FIG. 1, a flow chart of an exemplary method of decision tree based search result ranking is shown in accordance with a first embodiment of the present disclosure. The method 100 starts in step 101, where a training data set is obtained for generating at least one decision tree which is used for ranking search results. The training data set has N training features, where N is a natural number greater than or equal to 2. In step 102, the computational system of decision trees is divided into N feature work groups, each feature work group corresponding to a training feature of the N training features respectively. Then in step 103, by use of the feature work groups, optimal splitting nodes and optimal splitting values corresponding to the optimal splitting nodes are computed for each decision tree. Based on the computed optimal splitting nodes and optimal splitting values, each decision tree is generated accordingly. The method 100 concludes after step 104, where the search results are ranked using all the generated decision trees.

In some preferred embodiments of the present disclosure, the number of decision trees is greater than or equal to 2; and the step 103 further includes the step of determining whether the total number of the splitting nodes computed for the present decision tree exceeds a pre-determined threshold value. If so, the step 103 concludes computing optimal splitting nodes and their corresponding splitting values, and starts to generate a next decision tree, or proceeds to step 104.

If not, for each feature work group, the step 103 further includes the steps of independently computing a present optimal splitting value for the training feature corresponding to the feature work group; and transmitting amongst the feature work groups, where a present optimal splitting value for the present decision tree is selected from all the present optimal splitting values computed for the training feature by the feature work groups, and the training feature corresponding to the feature group from which the selected present optimal splitting value is computed, is assigned as a present optimal splitting node for the present decision tree. The step 103 further includes, by use of the feature work group corresponding to the selected present optimal splitting value, based on the present decision tree's present optimal splitting values and present optimal splitting nodes, splitting the training data set to form present splitting nodes, where splitting results of the splitting nodes are transmitted to the computational system of decision trees.

Furthermore, in some other preferred embodiments of the present disclosure, the above described step 104 includes the steps of fitting all the decision trees to obtain a ranking decision tree, and ranking search results based on degrees of relevance. The search results are retrieved using a search query, and the degrees of relevance are computed between the search results and the search query using the ranking decision tree.

In yet some other preferred embodiments of the present disclosure, the step 101 includes the step of obtaining the training data set from search histories collected on an e-commerce platform.

In accordance with embodiments of the present disclosure, each work group can communicate information in an inter-groups manner amongst work groups, as well as in an intra-group manner amongst communication nodes, forming a communication domain. Further, all work groups can perform data processing in parallel.

The usage of dividing the computational system of decision trees into feature work groups based on training features, and the parallel computation and transmission of information amongst the feature work groups, provides for training with training data sets of significantly large volumes, e.g., hundreds of millions of data, with computational time decreased to a great extent. Especially for search engines with large correspondent databases, it provides for fast and precise training for a good quality decision tree which can be used for ranking, increasing ranking efficiency and ranking flexibility, as well as lowering ranking associated costs.

A second embodiment in accordance with the present disclosure relates to a method of decision tree based research result ranking. The second embodiment improves upon the first embodiment of the present disclosure, the improvements being dividing the computational system of decision trees in the two dimensions of training features and training samples at the same time, further providing for increased training efficiency for training data sets, and therefore increased ranking efficiency. For example, for a training data set with 3 hundreds of millions of data, a good quality decision tree model can be trained within few hours.

In particular, the above described training data set includes M training samples, where M is a natural number greater than or equal to 2. The above described step 102 further includes the step of dividing each feature work group into M communication nodes corresponding to the M training samples respectively, where communication nodes belonging to different feature work groups but the same training sample form one sample work group. And, for the above described step of “for each feature work group, independently computing an optimal splitting value for the training feature corresponding to the feature work group” further includes the steps of: based on the generated decision trees corresponding to the training data set, for each sample work group, independently computing a gradient for each training sample of the sample work group; and based on the computed gradients, for each feature work group, independently computing an optimal splitting value for the training feature corresponding to the feature work group.

Further, it is understood that, in accordance with other alternative embodiments of the present disclosure, based on generated decision trees, by use of sample work groups, mis-classification information can be computed for each training sample. In other words, with an Adaboost decision tree model, mis-classification information can be used to compute the optimal splitting nodes and optimal splitting values for the present to-be-generated decision tree. Furthermore, it can also be implemented to generate each decision tree, and then to fit all the generated decision trees into a final decision tree used for ranking, i.e., with a random forest model.

In accordance with other alternative embodiments of the present disclosure, a feature work group can be divided into a number of less than M communication nodes, i.e., each sample work group can correspond to at least 2 training samples. For M training samples, each feature work group can be divided into K groups, where K is a natural number and less than M. K does not necessarily equal M, for example, when K equals 2, then M training samples are divided into 2 groups, each feature work group having samples from 2 sample work groups.

In order to generate a first decision tree, each training sample can be assumed as having an initial value of 0 for the purpose of computing a gradient for each training sample for generating a first decision tree.

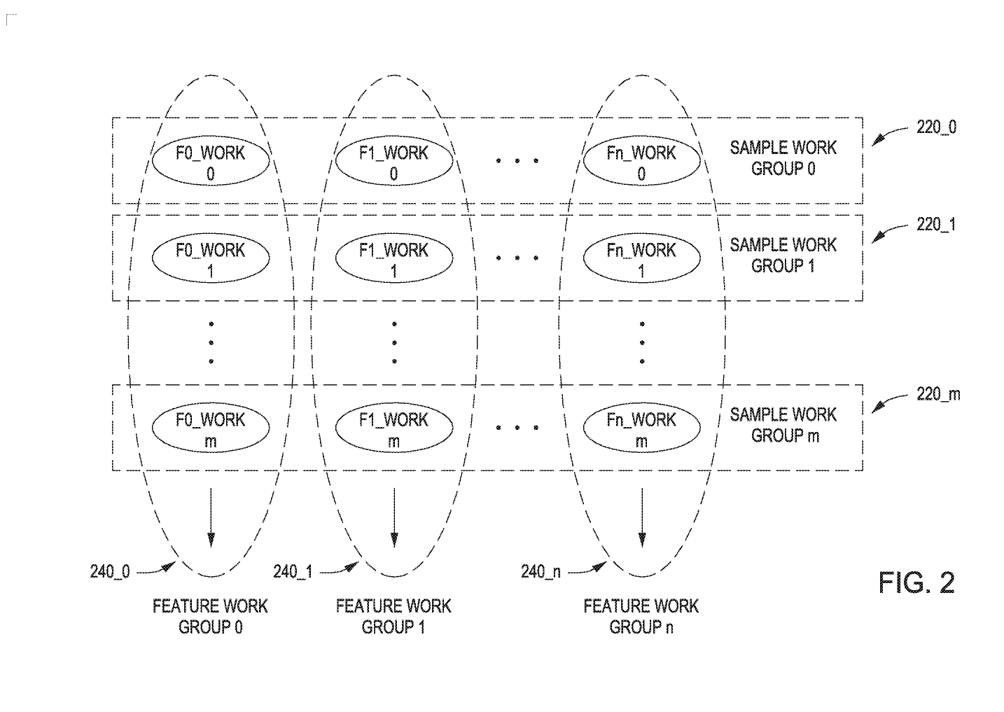

In accordance with another preferred embodiment of the present disclosure, the computational system of decision trees uses information gateway Message Based Passing Interface (MPI) protocols to accomplish the above described dividing into feature work groups and information communication amongst feature work groups. As shown in FIG. 2, using MPI, the computational system of decision tress is divided into N by M communication nodes, with N feature work groups 240_0, 240_1, . . . , 240_n and M sample work groups 220_0, 220_1, . . . m 220_m, where n and m are natural numbers. Data of the training data set has a schema of <target> <qid:query ID> <featureID1:value1> <featureID2:value2> . . . <featureIDn:valuen>, where <target> represents the target value for the present training sample, <qid:query ID> represents the present query identification, and <featureIDi:valuei> represents the value for the i feature, i being a natural number between 1 and n.

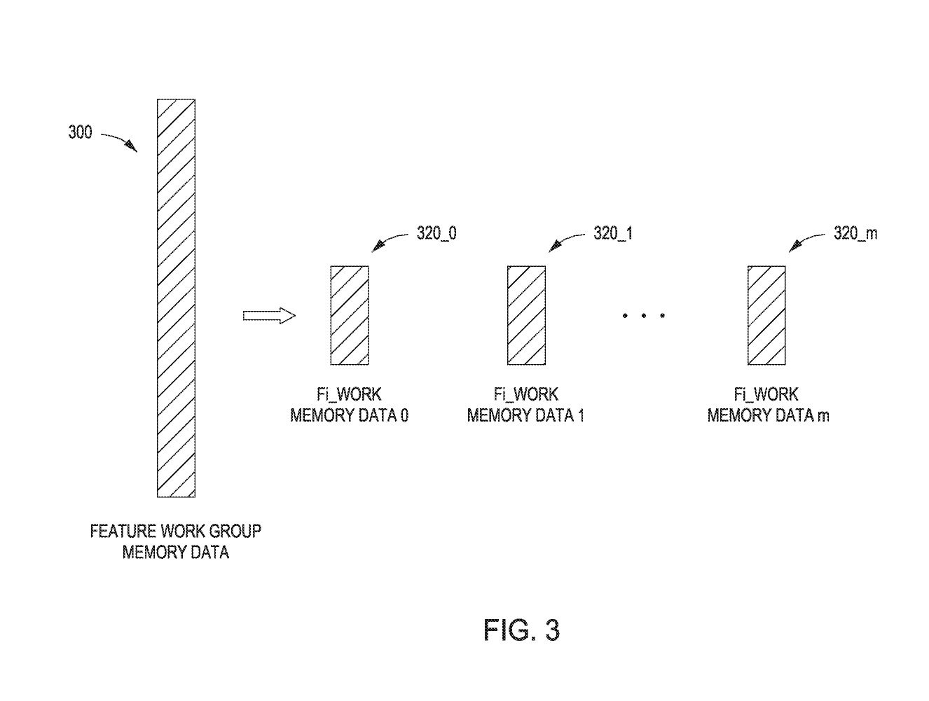

Each feature work group can communicate in an intra-group manner, each feature working group includes M communication nodes, each sample work group includes N communication nodes. During the entire computing process, data is stored in a distributed manner in the memory. As shown in FIG. 3, data of the training data sets is divided based on training features, each training feature is stored by its corresponding feature work group as feature work group memory data 300 in the memory. Separately, further dividing the training features such that each communication node of a feature work group stores partial data, for example, in the form of Fi_work memory data 320_0, 320_1, . . . , 320_m. As shown in FIG. 3, for example, with data divided based on queries, feature work groups' communication nodes (i.e., F1_work m, F2_work 1 etc.) store the following data: (1) training samples' feature values after division, (2) training samples' query ids after division, (3) training samples' target change values. Each sample work group also needs to store additional training related information such as (1) a training sample's negative gradient after division and (2) a training sample's present predicative value after division.

The following, using the GBDT model as an example, illustrates a method of generating a GBDT ranking decision tree based on MPI protocols, in accordance with an embodiment of the present disclosure.

In generating a ranking decision tree using the GBDT model, there are two important steps: obtaining training samples' negative gradients, and generating decision trees.

(1) Obtain Training Samples' Negative Gradients

Data stored on sample work groups' communication nodes is evenly divided (in other alternative embodiments of the present disclosure, data can be divided using other methods, depending on circumstances). For example, if the total number of sample queries is q_total, then sample work group 0 stores (0, q_total/M) sequence of data, sample work group 1 stores (q_total/M, q_total/M*2) sequence of data, and so on. Sample work groups are independent from each other, to establish a present decision tree, based on previously established decision trees, independently compute their respective sample work group's divided samples' negative gradients. If there are M sample work groups, then every sample work group only computes one sample negative gradient. If there are less than M sample work groups, then every sample group computes more than one sample negative gradients. The communication nodes of a sample work group can co-operate to compute gradients, every real communication node computing part of sample gradients, after computation, using intra-work group communication to obtain all the gradients for the sample work group.

(2) Establish Decision Trees

The process of generating decision trees primarily is to compute, for a presently to be generated decision tree, optimal splitting points and their respective optimal splitting values, and to perform the splitting of the training data sets accordingly.

A) Work Group Computing Optimal Splitting Points

Each feature work group computes its respective training feature's optimal splitting points, with statistics of all the feature work groups, global optimal splitting nodes (fid) and the corresponding optimal splitting values (split_value) can be obtained.

When a feature work group computes an optimal splitting value (split_value) for the present feature, as each communication node of the feature work group only stores part of the data, it is necessary to access data stored at all the communication nodes of the feature work group in order to compute an optimal splitting value. Detailed computation of an exemplary feature work group is illustrated in the following:

All the communication nodes of each feature work group compute candidate splitting values' regional samples' left_sum (a negative gradient of the left node after splitting) and left_count (a count of the number of samples at the left node after splitting), forming a three element unit with a schema of <split_value, left_sum, left_count>. Here, there is no right_sum (a negative gradient of the right node after splitting), or right_count (a count of the number of samples at the right node after splitting), because left_sum can be computed by subtracting left_sum from the present node_sum (the total number of nodes), for the purpose of reducing the amount of communication inside the feature work group.

Communication node zero of each feature work group collects from other communication nodes of the feature work group their computed three element unit information; computes for each candidate splitting value a gain Critmax=left_sum*left_sum/left_count+right_sum*right_sum/right_count; and sets the candidate splitting value corresponding to a largest Critmax as the optimal splitting point for the corresponding training feature of the feature work group. It is understood that in other alternative embodiments of the present disclosure, communication nodes of the feature work group other than node zero can also be implemented, without any particular limitation, to collect the three element unit information from the rest of communication nodes of the feature work group.

The optimal splitting nodes of the feature work group with the largest Critmax are selected as the present optimal splitting values for the present decision tree. The training feature corresponding to the feature work with the larger Critmax is selected as the present optimal splitting nodes for the present decision tree. It is also understood that in other alternative embodiments of the present disclosure, other methods can be used to compute the optimal splitting nodes and the optimal splitting values, not limited to the above described Critmax based computation.

B) Splitting at the Optimal Splitting Nodes

Each communication node of the feature work group maintains a table of node id for the present work group's training samples. At splitting, the table of node id is updated. When the optimal splitting feature (i.e., optimal splitting node) (fid) and the corresponding optimal splitting values (split_value) are determined, only the feature work group corresponding to the optimal split nodes performs the splitting using the optimal splitting node and updates the node id table accordingly. The other feature work groups don't have feature value for the fid. Detailed implementation of an exemplary splitting is illustrated as the following: the feature work group of fid performs splitting, records information that indicates each sample is split into the left node or the right node, for example, utilizes 0 or 1 as indicators, where 0 indicates left node and 1 indicates right node, saves the indication information into a bitmap, and broadcasts it to the other feature work group.

To generate an IGBT ranking model based on multiple decision trees, an exemplary work flow is illustrated as the following: (1) load for the computational system operative parameters and each sample's data sets; (2) to generate the i decision tree, using sample work groups, compute a negative gradient for each sample, based on the prior i−1 decision trees. (When i=1, the sample's initial value is set to 0 for computing negative gradients, for example, to compute with loss functions as a constant). Next, with the computed negative gradients, use the feature work groups to compute the present decision tree's optimal splitting nodes and corresponding optimal splitting values. In the process of computing the j optimal splitting node, it is necessary to determine whether the total number of the nodes of the present decision tree exceeds a pre-determined threshold number; or whether it still has the feature suitable as an optimal splitting node. If no, then compute a j optimal splitting node. Otherwise, conclude the computation of optimal splitting nodes, generate the i decision tree, and start the computation to build the next decision tree or directly fitting the generated i decision tree into a ranking decision tree, i.e., an IGBT ranking model.

In addition, it is understood that, in other alternative embodiments of the present disclosure, other parallel transmission communication protocols can also be implemented to divide the computational system.

Embodiments of the present disclosure can be implemented using software, hardware, firmware, and/or the combinations thereof. Regardless of being implemented using software, hardware, firmware or the combinations thereof, instruction code can be stored in any kind of computer readable media (for example, permanent or modifiable, volatile or non-volatile, solid or non-solid, fixed or changeable medium, etc.). Similarly, such mediums can be implemented using, for example, programmable array logic (PAL), random access memory (RAM), programmable read only memory (PROM), read only memory (ROM), electrically erasable programmable ROM (EEPROM), magnetic storage, optical storage, digital versatile disc (DVD), or the like.

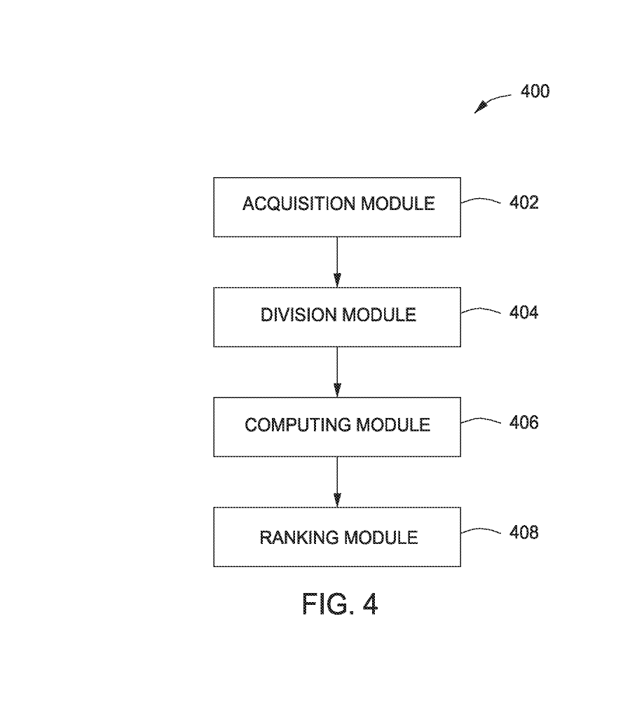

Referring to FIG. 4, a block diagram of an exemplary apparatus for decision trees based search result ranking in accordance with a third embodiment of the present disclosure is shown. The apparatus 400 includes an acquisition module 402 configured for obtaining a training data set to establish at least one decision tree. The training data set has N associated training features, where N is a natural number greater than or equal to 2. The apparatus 400 further includes a division module 404 configured for dividing the computational system of decision trees into N feature work groups, each feature work group corresponding to a training feature of the N training features respectively. The apparatus 400 also includes a computing module 406 configured for using the feature work groups to computing optimal splitting nodes and optimal splitting values corresponding to the optimal splitting nodes for each decision tree, and to generate each decision tree using the computed optimal splitting nodes and optimal splitting values. The apparatus 400 further includes a ranking module 408 configured for ranking search results using the decision trees.

In some embodiments in accordance with the present disclosure, the total number of the above described decision trees is greater than or equal to 2; and the above described computing module includes the following sub-modules: a counting sub-module configured for determining whether a number of optimal splitting nodes computed for a present decision tree exceeds a pre-determined threshold value; a computation conclusion sub-module configured for, when the counting sub-module returns a not-exceeding the threshold value condition, concluding the computation of optimal splitting nodes and optimal splitting values, and start to generate the next decision tree, or proceed to the ranking module. The computing module also includes an independent computing sub-module configured for, if the counting sub-module returns an exceeding the threshold value condition, for each feature work group, independently computing a optimal splitting value for the training feature corresponding to the feature work group. The computing module further includes a node assigning sub-module configured for transmitting amongst the feature work groups, where a present optimal splitting value for the present decision tree is selected from all the optimal splitting values computed for the feature work groups, where the training feature corresponding to the feature group, with which the selected present optimal splitting value is computed, is assigned as a present optimal splitting node for the present decision tree. The computing module also includes a node splitting sub-module configured for computing the present optimal splitting value's corresponding feature work group, based on the present decision tree's present optimal splitting value and present optimal splitting node's corresponding training samples, forming present splitting nodes, wherein splitting results are transmitted to the computational system of decision trees.

In a preferred embodiment of the present disclosure, the above described ranking module includes a decision tree fitting sub-module configured for fitting the generated decision trees to form a ranking decision tree; and a decision tree based ranking sub-module configured for ranking search results based on degrees of relevance, where the search results are retrieved using search queries and the degrees of relevance are computed between the search results and the search queries using the ranking decision tree.

In another preferred embodiment of the present disclosure, the above described acquisition module further includes a training data set obtaining module configured for obtaining the training data set from search histories collected on an e-commerce platform.

The first embodiment corresponds to the instant embodiment of the present disclosure, the instant embodiment can be implemented in cooperation with the first embodiment. The technical details described in the first embodiment apply to the instant embodiment, and are not repeated herein for the purposes of reducing repetition. Accordingly, the technical details described in the instant embodiment apply to the first embodiment.

The fourth embodiment of the present disclosure relates to an exemplary apparatus for ranking search results using decision trees. It improves upon the third embodiment of the present disclosure, the primary improvement being the division of the computational system of decision trees in two dimensions of training features and training samples, further increasing the training data's training efficiency, and therefore the ranking efficiency. For example, for 3 hundreds of millions of data, a good quality decision tree model can be created within few hours.

In particular, the above described training data set includes M training samples, where M is a natural number greater than or equal to 2. The above described division module includes a feature group division sub-module configured for dividing each feature work group into M communication nodes corresponding to the M training samples, where the communication nodes belonging to different feature work groups but to the same training sample form a sample work group.

The above described independent computing sub-module further includes a gradient computing sub-module configured for, based on the generated decision trees corresponding to the training data set, for each sample work group, independently computing a gradient for each training sample of the sample work group; and a splitting value computing sub-module configured for, based on the computed gradients, for each feature work group, independently computing an optimal splitting value for the training feature corresponding to the feature work group.

In a preferred embodiment of the present disclosure, a computation system of decision trees utilizes the MPI protocols to accomplish feature work group division and information transmission amongst feature work groups.

The second embodiment corresponds to the instant embodiment of the present disclosure, the instant embodiment can be implemented in cooperation with the second embodiment. The technical details described in the second embodiment apply to the instant embodiment, and are not repeated herein for the purposes of reducing repetition. Accordingly, the technical details described in the instant embodiment apply to the second embodiment.

It is necessary to point out that, modules or blocks described by embodiments of the present disclosures are logical modules or logical blocks. Physically, a logical module or logical block can be a physical module or a physical block, a part of a physical module or a physical block, or the combinations of more than one physical modules or physical blocks. Physical implementation of those logical module or logical blocks is not of essence. The realized functionalities realized by the modules, blocks and the combinations thereof are key to solving the problems addressed by the present disclosure. Further, in order to disclose the novelties of the present disclosure, the above described embodiments do not disclose about those modules or blocks not too related to solving the problems addressed by the present disclosure, which does not mean that the above described embodiments cannot include other modules or blocks.

It is also necessary to point out that, in the claims and specification of the present disclosure, terms such as first and second only are for distinguishing an embodiment or an operation from another embodiment or operation. It does not require or imply that those embodiments or operations having any such real relationship or order. Further, as used herein, the terms “comprising,” “including,” or any other variation intended to cover a non-exclusive inclusion, such that a process, method, article, or apparatus that comprises a list of elements does not include only those elements but may include other elements not expressly listed or inherent to such process, method, article, or apparatus. Absent further limitation, elements recited by the phrase “comprising a” does not exclude a process, method, article, or apparatus that comprises such elements from including other same elements.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable medium used to actually carry out the distribution. The embodiments disclosed herein may also be implemented using software modules that perform certain tasks. These software modules may include script, batch, or other executable files that may be stored on a computer-readable storage media or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

Although the present disclosure and its advantages have been described in detail, it should be understood that various changes substitutions, and alterations can be made herein without departing from the spirit and scope of the disclosure as defined by the appended claims. Many modifications and variations are possible in view of the above teachings. The embodiments were chosen and described in order to optimal explain the principles of the disclosure and its practical applications, to thereby enable others skilled in the art to optimal utilize the disclosure and various embodiments with various modifications as may be suited to the particular use contemplated.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Embodiments according to the present disclosure are thus described. While the present disclosure has been described in particular embodiments, it should be appreciated that the disclosure should not be construed as limited by such embodiments, but rather construed according to the below claims.

What is claimed is:

1. A method of decision tree based search result ranking, the method comprising:
obtaining a training data set for generating at least one decision tree, the training data set having N training features, wherein N is greater than or equal to 2;
dividing a computational system of decision trees into N feature work groups corresponding to the N training features respectively;
computing, based upon the feature work groups, optimal splitting nodes and optimal splitting values corresponding to the optimal splitting nodes for the decision trees;
generating the decision trees using the computed optimal splitting nodes and the corresponding optimal splitting values; and
ranking search results using the decision trees.

2. The method of claim 1, further comprising:
computing, when a total number of the generated decision trees is greater than or equal to 2, splitting of the nodes by determining whether a number of splitting nodes computed for the decision tree exceeds a pre-determined threshold value.

3. The method of claim 2, further comprising:
computing, if the number of the optimal splitting nodes does not exceed the threshold value for each feature work group, an optimal splitting value for the training feature corresponding to the feature work group;
transmitting, when a present splitting value for a present decision tree is selected from substantially all the optimal splitting values for the training feature of the feature work groups, amongst the feature work groups,
assigning the training feature corresponding to the feature group from which the selected present splitting value is computed as a present optimal splitting node for the present decision tree; and
splitting, by use of the feature work group corresponding to the selected splitting value and based upon a decision tree's splitting value and splitting node, the training data set to form splitting nodes, wherein a splitting result of the splitting nodes are transmitted to the computational system.

4. The method of claim 3, further comprising:
dividing, when the training data set has M training samples and M is greater than or equal to 2, the computational system of decision trees by dividing each feature work group into M communication nodes corresponding to the M training samples, wherein communication nodes belonging to different feature work groups but to a same training sample form a sample work group; and
computing a splitting value by computing, based upon the generated decision trees corresponding to the training data set for each sample work group, gradients for training samples of the sample work group; and
computing, based on the computed gradients, for each feature work group, a splitting value for the training feature corresponding to the feature work group.

5. The method of claim 1, wherein ranking search results comprises:
fitting the generated decision trees to form a ranking decision tree; and
ranking search results based on degrees of relevance, wherein the search results are retrieved using search queries and the degrees of relevance are computed between the search results and the search queries using the ranking decision tree.

6. The method of claim 1, wherein the computational system of decision trees utilizes Message Passing Interface (MPI) protocols to divide feature work groups and to transmit information amongst groups.

7. The method of claim 1, further comprising obtaining the training data set from search histories collected on an e-commerce platform.

8. An apparatus for ranking search results based on decision trees, the apparatus comprising:
a processor; and
a non-transitory computer-readable medium operably coupled to the processor, the non-transitory computer-readable medium having computer-readable instructions stored thereon to be executed when accessed by the processor, the instructions comprising:
an acquisition module configured for obtaining a training data set for generating at least one decision tree, the training data set having N training features, wherein N is greater than or equal to 2;
a division module configured for dividing a computational system of decision trees into N feature work groups corresponding to the N training features respectively;
a computing module configured for computing, based upon the feature work groups, optimal splitting nodes and optimal splitting values corresponding to the optimal splitting nodes for the decision trees; and for generating the decision trees using the optimal splitting nodes and the corresponding optimal splitting values; and
a ranking module configured for ranking search results using the decision trees.

9. The apparatus of claim 8, wherein the computing module comprises:
a counting sub-module configured for determining, when a total number of the generated decision trees is greater than or equal to 2, whether a number of splitting nodes computed for a decision tree exceeds a pre-determined threshold value.

10. The apparatus of claim 9, wherein the computing module further comprises:
an independent computing sub-module configured for computing, if the number of the optimal splitting nodes does not exceed the threshold value for each feature work group, an optimal splitting value for the training feature corresponding to the feature work group;
a node assigning sub-module configured for transmitting, when a present splitting value for a present decision tree is selected from substantially all the optimal splitting values for the training feature of the feature work groups, amongst the feature work groups, and assigning the training feature corresponding to the feature group from which the selected present splitting value is computed as a present optimal splitting node for the present decision tree; and
a node splitting sub-module configured for splitting, by use of the feature work group corresponding to the selected splitting value and based upon a decision tree's splitting value and splitting node, the training data set to form splitting nodes, wherein a splitting result of the splitting nodes are transmitted to the computational system.

11. The apparatus of claim 10, wherein the division module comprises:
a feature group division sub-module configured for dividing, when the training data set has M training samples and M is greater than or equal to 2, each feature work group into M communication nodes corresponding to the M training samples, wherein communication nodes belonging to different feature work groups but to a same training sample form a sample work group; and the computing sub-module comprises:
a gradient computing sub-module configured for computing, based upon the generated decision trees corresponding to the training data set for each sample work group, gradients for training samples of the sample work group; and
a splitting value computing sub-module configured for computing, based on the computed gradients, for each feature work group, a splitting value for the training feature corresponding to the feature work group.

12. The apparatus of claim 8, wherein the ranking module comprises:
a decision tree fitting sub-module configured for fitting the generated decision trees to form a ranking decision tree; and
a decision tree based ranking sub-module configured for ranking search results based on degrees of relevance, wherein the search results are retrieved using search queries, the degrees of relevance are computed between the search results and the search queries using the ranking decision tree.

13. The apparatus of claim 8, wherein the computational system of decision trees utilizes Message Passing Interface (MPI) protocols to divide feature work groups and to transmit information amongst groups.

14. The apparatus of claim 8, wherein the acquisition module comprises a training data set acquisition sub-module configured for obtaining the training data set from search histories collected on an e-commerce platform.

15. A non-transitory computer readable storage medium having embedded therein program instructions, when executed by one or more processors of a device, causes the device to execute a process for decision tree based search result ranking, the process comprising:
obtaining a training data set for generating at least one decision tree, the training data set having N training features, wherein N is greater than or equal to 2;
dividing a computational system of decision trees into N feature work groups corresponding to the N training features respectively;
computing, based upon the feature work groups, optimal splitting nodes and optimal splitting values corresponding to the splitting nodes for the decision trees;
generating the decision trees using the computed optimal splitting nodes and the corresponding optimal splitting values; and
ranking search results using the decision trees.

16. The non-transitory computer readable storage medium of claim 15, wherein the process further comprises computing, when a total number of the generated decision trees is greater than or equal to 2, splitting nodes by determining whether a number of splitting nodes computed for a decision tree exceeds a pre-determined threshold value.

17. The non-transitory computer readable storage medium of claim 16, the process further comprises:
computing, if the number of the optimal splitting nodes does not exceed the threshold value for each feature work group, an optimal splitting value for the training feature corresponding to the feature work group;
transmitting, when a present splitting value for a present decision tree is selected from substantially all the optimal splitting values for the training feature of the feature work groups, amongst the feature work groups,
assigning the training feature corresponding to the feature group from which the selected present splitting value is computed as a present optimal splitting node for the present decision tree; and
splitting, by use of the feature work group corresponding to the selected splitting value and based upon a decision tree's splitting value and splitting node, the training data set to form splitting nodes, wherein a splitting result of the splitting nodes are transmitted to the computational system.

18. The non-transitory computer readable storage medium of claim 17, wherein the process further comprises:
dividing, when the training data set has M training samples and M is greater than or equal to 2, the computational system of decision trees by dividing each feature work group into M communication nodes corresponding to the M training samples, wherein communication nodes belonging to different feature work groups but to a same training sample form a sample work group; and
computing a splitting value by computing, based upon the generated decision trees corresponding to the training data set for each sample work group, gradients for training samples of the sample work group; and
computing, based on the computed gradients, for each feature work group, a splitting value for the training feature corresponding to the feature work group.

19. The non-transitory computer readable storage medium of claim 15, wherein ranking search results comprises:
fitting the generated decision trees to form a ranking decision tree; and
ranking search results based on degrees of relevance, wherein the search results are retrieved using search queries the degrees of relevance are computed between the search results and the search queries using the ranking decision tree.

20. The non-transitory computer readable storage medium of claim 15, wherein the computational system of decision trees utilizes Message Passing Interface (MPI) protocols to divide feature work groups and to transmit information amongst groups.

21. The non-transitory computer readable storage medium of claim 15, wherein obtaining training data set for at least one decision tree comprises obtaining the training data set from search histories collected on an e-commerce platform.
